(19) United States
(12) Patent Application Publication
(10) Pub. No.: US 2006/0020099 A1
(43) Pub. Date: Jan. 26, 2006

(54) Catalyst and process

(76) Inventors: Bruno Frederic Stengel, Eaglescliffe (GB); David Jenkins, Cleveland (GB)

Correspondence Address: RATNERPRESTIA, P O BOX 980, VALLEY FORGE, PA, 19482-0980, US

(21) Appl. No.: 10/535,046

(22) PCT Filed: Nov. 12, 2003
(86) PCT No.: PCT/GB03/04921

§ 371 Date: May 13, 2005

(30) Foreign Application Priority Data
Nov. 13, 2002 (GB) 0226408.3

(51) Int. Cl. C08G 18/00

(52) U.S. Cl. 528/44

(57) ABSTRACT

The invention concerns an organometallic compound of formula RO-M(L¹)_{X} (L²)_{Y} (L³)_{Z} wherein M is a metal selected from titanium, zirconium, hafnium, iron (III), cobalt (III) or aluminium; L¹ and L² are each independently selected from a diketonate, an ester or amide of acetoacetic acid, a hydroxycarboxylic acid or ester thereof, R¹COO— where R¹ is substituted or unsubstituted C₅-C₃₀ branched or linear alkyl, substituted or unsubstituted aryl including polycyclic structures such as naphthyl or anthracyl, phosphate, phosphinate, phosphonate, siloxy or sulphonato, provided that when L¹ is a ligand which forms two covalent bonds with the metal atom, and x=1 then y=0; L³ is selected from substituted or unsubstituted aryloxy, R²COO— where R² is a linear or branched C₆-C₃₀ alkyl or a substituted or unsubstituted aryl, a polyoxyalkyl or hydroxyalkoxyalkylgroup; R is alkyl or hydroxy-alkyl hydroxyalkoxyalkyl, or (hydroxy)polyoxyalkyl group, x, y and z are each either 0 or 1 (x+y+z)≦V−1, where V=the valency of the metal M. The invention further concerns compositions and processes for the manufacture of polyurethane articles using the organometallic compounds as catalysts to provide cured articles having a comparable performance to those produced using a commercial mercury-based catalyst.

The present invention relates to catalysts which are useful in the preparation of certain polymers, particularly polyurethanes, and to processes and intermediates in which the catalysts are used.

Catalysts comprising compounds of titanium or zirconium are well known for use in many applications such as in esterification reactions and for curing reaction mixtures containing isocyanate and hydroxylic species to form polyurethanes. Typically, such catalysts comprise a metal alkoxide, such as titanium tetra isopropoxide, or a chelated species derived from the alkoxides.

In polyurethane manufacture the catalysts of choice in many applications have, for many years, been organic mercury compounds. This is because these catalysts provide a desirable reaction profile which offers an initial induction period in which the reaction is either very slow or does not take place, followed by a rapid reaction which continues for sufficient time to produce a relatively hard polymer article. The induction time, also known as the pot life, is desirable because it allows the liquid reaction mixture to be poured or moulded after addition of the catalyst and therefore gives the manufacturer more control over the manufacturing process. The rapid and complete reaction after the pot life is important to provide finished articles which are not sticky and which develop their desired physical properties quickly to allow fast turnaround in the production facility.

It is, however, known that mercury compounds are toxic and so there is a need for catalysts which do not contain mercury and yet which offer the manufacturer the desirable reaction profile which is offered by the known mercury-containing catalysts. Although titanium alkoxides provide very effective catalysts for polyurethane cure reactions, they do not produce a reaction profile with the desirable pot life and cure profile described above. In many cases the reaction may be very rapid but offers no induction period and so the polyurethane mixture tends to gel very quickly, often before it can be cast into its final shape. A further problem is that, despite the rapid initial reaction, the resulting polyurethane does not achieve a satisfactory degree of cure within a reasonable time. This results in finished articles which are sticky and difficult to handle and which may have inferior physical properties compared with articles made using a mercury catalyst.

It is an object of the invention to provide an effective catalyst compound which does not contain mercury and which may be used to manufacture polyurethane articles.

Monoalkoxytitanates such as titanium monoisopropoxy tris(isostearate) are well known for use as coupling agents between inorganic materials and organic polymeric materials. For example U.S. Pat. No. 4,397,983 disdoses the use of isopropyl tri(dodecylbenzenesulfononyl) titanate and isopropyl tri(dioctylphosphato) titanate for coupling fillers in polyurethanes.

U.S. Pat. No. 4,122,062 describes organotitanates having one of the following formulas:
a) (RO)_{z}Ti(A)ₓ(B)_{y} or
b) (RO)Ti(OCOR′)ₚ(OAr)_{q} wherein R is a monovalent alkyl, alkenyl, alkynyl, or aralkyl group having from 1 to 30 carbon atoms or substituted derivatives thereof; A is a thioaroxy, sulfonyl, sulfinyl, diester pyrophosphate, diester phosphate, or a substituted derivative thereof; OAr is aroxy, B is OCOR′ or OAr; R′ is hydrogen or a monovalent organic group having from 1 to 100 carbon atoms; x+y+z equal 4; p+q equal 3; x, z and q may be 1, 2 or 3; and y and p may be 0, 1 or 2; the reaction products of such organo-titanates and comminuted inorganic material; and polymeric materials containing such reaction products. The products are used as coupling agents to improve the dispersion of fillers in polymeric materials and the properties of the resulting filled polymers.

U.S. Pat. No. 4,094,853 describes a composition of matter comprising the reaction product of a comminuted inorganic material and an organo-titanate having the formula (RO)Ti(OCOR′)₃ wherein R is a monovalent alkyl, alkenyl, alkynyl or aralkyl group having from 1 to 30 carbon atoms or a substituted derivative thereof, R′ is a monovalent organic group the total number of carbon atoms in the three R′ groups in a molecule being not more than 14; and polymeric materials containing such reaction products.

EP-A-0164227 describes neoalkoxy compounds having the formula
R R¹R²CCH₂OM(A)ₐ(B)_{b}(C)_{c} wherein M is titanium or zirconium, R, R¹ and R² are each a monovalent alkyl, alkenyl, alkynyl, aralkyl, aryl or alkaryl group having up to twenty carbon atoms or a halogen or ether substituted derivative thereof, and, in addition, R² may also be an oxy derivative or an ether substituted oxy derivative of said groups; A, B, and C are each a monovalent aroxy, thioaroxy, diester phosphate, diester pyrophosphate, oxyalkylamino, sulfonyl or carboxyl containing up to 30 carbon atoms; and a+b+c=3. The compound is useful as a coupling and polymer processing agent and compositions containing the compound and methods of preparing polymeric material including the compound are also described.

GB-A-1509283 describes novel organo-titanates represented by the formula:
Ti(OR)₄₋ₙ (OCOR′)ₙ where OR is a hydrolyzable group; R′ is a non-hydrolyzable group; and n is between about 3.0 and 3.50, preferably from 3.1 to 3.25. R, may be a straight chain, branched or cyclic alkyl group having from 1 to 5 carbon atoms per molecule. The non-hydrolyzable groups (OCOR′) are preferably formed from organic acids having 6 to 24 carbon atoms, such as stearic, isostearic, oleic, linoleic, palmiuc, lauric and tall oil acids. The compounds are used for treating inorganic solids to improve the dispersion of the inorganic solids in polymeric compounds and to improve the physical properties of the filled polymeric compounds, i.e. the organo-titanates are used as coupling agents.

Monte and Sugerman (Journal of Cellular Plastics, November-December 1985, p 385) describe the use of various neoalkoxytitanates and neoalkoxyzirconates as coupling agents in different polymer systems. They conclude that certain of the compounds are capable of directly catalysing the polyol-isocyanate reaction in addition to bonding polymer to substrate.

U.S. Pat. No. 2,846,408 describes a process for preparing cellular polyurethane plastics of specified pore structure using metallic compounds defined by the general formula Me(OR)ₘXₙ₋ₘ where R is alkyl and X is an organic carboxylic acid radical including lauric, stearic, palmitic, naphthenic and phenylacetic acids, m is at least 1 and n is the valence of the metal Me. Me includes titanium, zirconium and tin. U.S. Pat. No. 2,926,148 describes catalysts for the reaction between a diisocyanate and a mixture of alcohols to form resins. The catalysts include, apart from tin compounds, tetralkyl titanates and zirconates and various titanium esters which include triethanolamine titanate-N-stearate, triethanolamine titanate-N-oleate, octylene glycol titanate and triethanolamine titanate. U.S. Pat. No. 6,133,404 describes the use of monoalkoxytitanates as additives useful in the preparation of biodegradeable polyester compositions. U.S. Pat. No. 5,591,800 describes the manufacture of polyesters using a cyclic titanium catalyst such as a titanate compound formed by the reaction of a tetra-alkyl titanate and a triol.

According to the invention we provide an organometallic compound of formula
RO—M(L¹)ₓ(L²)_{y}(L³)_{z}
wherein M is a metal selected from titanium, zirconium, hafnium, iron (III), cobalt (III) or aluminium;
R is alkyl or a hydroxy-alkyl, hydroxyalkoxyalkyl, or (hydroxy)polyoxyalkyl group, and
(i) when R is alkyl, L¹ and L² are each independently selected from a β-diketonate, an ester or amide of acetoacetic acid, a hydroxycarboxylic acid or ester thereof, siloxy, or a substituted or unsubstituted phenol or naphthol,
(ii) when R is a hydroxy-alkyl hydroxyalkoxyalkyl, or (hydroxy)polyoxyalkyl group:
L¹ and L² are each independently selected from a diketonate, an ester or amide of acetoacetic acid, a hydroxycarboxylic acid or ester thereof, R¹COO— where R¹ is substituted or unsubstituted C₁-C₃₀ branched or linear alkyl, substituted or unsubstituted aryl including polycyclic structures such as naphthyl or anthracyl, phosphate, phosphinate, phosphonate, siloxy or sulphonato;
in both case (i) and case(ii), provided that when L¹ is a ligand which forms two covalent bonds with the metal atom, and x=1 then y=0;
L³ is selected from substituted or unsubstituted aryloxy, R²COO— where R² is a linear or branched C₁-C₃₀ alkyl or a substituted or unsubstituted aryl, a polyoxyalkoxy or hydroxyalkoxyalkoxy group;
x and y are each either 0 or 1,
z=1
(x+y+z)≦V−1, where V=the valency of the metal M.

According to a further aspect of the invention we also provide a composition comprising:
a) either
   i) a compound having more than one hydroxy group which is capable of reacting with an isocyanate group-containing material to form a polyurethane or
   ii) a compound having more than one isocyanate group which is capable of reacting with a hydroxyl group-containing material to form a polyurethane,
b) an organometallic compound of formula RO-M(L¹)ₓ(L¹)_{y}(L³)_{z}
   wherein M is a metal selected from titanium, zirconium, hafnium, iron (III), cobalt (III) or aluminium;
L¹ and L² are each independently selected from a diketonate, an ester or amide of acetoacetic acid, a hydroxycarboxylic acid or ester thereof, R¹COO— where R¹ is substituted or unsubstituted C₁-C₃₀ branched or linear alkyl, substituted or unsubstituted aryl including polycyclic structures such as naphthyl or anthracyl, phosphate, phosphinate, phosphonate, siloxy or sulphonato, provided that when L¹ is a ligand which forms two covalent bonds with the metal atom, and x=1 then y=0;
L³ is selected from substituted or unsubstituted aryloxy, R²COO— where R² is a linear or branched C₁-C₃₀ alkyl or a substituted or unsubstituted aryl, a polyoxyalkyl or hydroxyalkoxyalkyl group;
R is alkyl or hydroxy-alkyl hydroxyalkoxyalkyl, or (hydroxy)polyoxyalkyl group, x, y and z are each either 0 or 1
(x+y+z )≦V−1, where V=the valency of the metal M; and optionally
c) one or more further components selected from chain modifiers, diluents, flame retardants, blowing agents, release agents, water, coupling agents, lignocellulosic preserving agents, fungicides, waxes, sizing agents, fillers, colourants, impact modifiers, surfactants, thixotropic agents, flame retardants, plasticisers, and other binders.

According to a further aspect of the invention, we also provide a process for the manufacture of a polyurethane article, comprising the steps of:
a) forming a mixture by mixing together either
   i) a compound having more than one hydroxy group which is capable of reacting with an isocyanate group-containing material to form a polyurethane or
   ii) a compound having more than one isocyanate group which is capable of reacting with a hydroxyl group-containing material to form a polyurethane,
      with an organometallic compound of formula RO-M(L¹)ₓ(L²)_{y}(L³)_{z}
      wherein M is a metal selected from titanium, zirconium, hafnium, iron (III), cobalt (III) or aluminium;
L¹ and L² are each independently selected from a diketonate, an ester or amide of acetoacetic acid, a hydroxycarboxylic acid or ester thereof, R¹COO— where R¹ is substituted or unsubstituted C₁-C₃₀ branched or linear alkyl, substituted or unsubstituted aryl including polycyclic structures such as naphthyl or anthracyl, phosphate, phosphinate, phosphonate, siloxy or sulphonato, provided that when L¹ is a ligand which forms two covalent bonds with the metal atom, and x=1 then y=0;
L³ is selected from substituted or unsubstituted aryloxy, R²COO— where R² is a linear or branched C₁-C₃₀ alkyl or a substituted or unsubstituted aryl, a polyoxyalkyl or hydroxyalkoxyalkyl group;
R is alkyl or hydroxy-alkyl hydroxyalkoxyalkyl, or (hydroxy)polyoxyalkyl group, x, y and z are each either 0 or 1
(x+y+z )≦V−1, where V=the valency of the metal M;
b) adding to said mixture the other of the compound having more than one hydroxy group which is capable of reacting with an isocyanate group-containing material to form a polyurethane or the a compound having more than one isocyanate group which is capable of reacting with a hydroxyl group-containing material to form a polyurethane,
c) forming said mixture into the required shape for the polyurethane article,
d) allowing said mixture to cure
e) optionally subjecting the mixture to specified conditions for post-cure conditioning.

According to a further aspect of the invention we provide a process for manufacturing an organometallic composition comprising reacting together:-
(a) a metal alkoxide, having a formula M(OR)ᵥ, where:
M is a metal selected from titanium, zirconium, hafnium, iron (III), cobalt (III) or aluminium;
V=the valency of the metal M, and
R is alkyl, and
(b) a β-diketone, an ester or amide of acetoacetic acid, a hydroxycarboxylic acid or ester thereof, R¹COO— where R¹ is substituted or unsubstituted C₁-C₃₀ branched or linear alkyl, substituted or unsubstituted aryl including polycyclic structures such as naphthyl or anthracyl, phosphate, phosphinate, phosphonate, siloxy or sulphonato; in an amount to provide about 1 or 2 moles of component (b) per mole of metal M in component (a); and
(c) a substituted or unsubstituted aryloxy, R²COO— where R² is a linear or branched C₁-C₃₀ alkyl or a substituted or unsubstituted aryl, a polyoxyalkylalcohol or hydroxyalkoxyalcohol in an amount to provide about 1 mole of component (c) per mole of metal M in component (a);
(d) optionally removing alcohol ROH formed during the reaction of (a) with (b) and (c).

It is preferred to perform step (d). In a preferred process, the metal alkoxide M(OR)ᵥ is first reacted with one of component (b) or component (c) and then with the other of components (b) or (c). The alcohol ROH formed during the reaction of the alkoxide with components (b) and (c) is preferably removed, normally by distillation, after each reaction step. Optionally, the product is further reacted with a hydroxy-functionalised alcohol which is preferably a hydroxy-alcohol, hydroxyalkoxyalcohol, or (hydroxy)polyoxyalkylalcohol and a further quantity of ROH is removed from the reaction mixture. By “about 1 (or 2) mole(s)” we mean that the quantities of reactants are calculated to provide approximately 1 or 2 moles per mole of metal, normally to ±10% would be suitable, especially to ±5% or less (e.g. ±2%) of the calculated quantity of the reactants.

According to a still further aspect of the invention, we provide the reaction product of the above-described process.

M is preferably titanium, zirconium or hafnium and is most preferably titanium or zirconium.

R is preferably an alkyl group, such as a C₁-C₂₂ alkyl, more preferably a C₁-C₈ alkyl. The group OR, is labile and provides an active site for catalysis. By labile, we mean that under the conditions of the reaction which is to be catalysed, the group OR may undergo substitution or insertion by one of the reactant molecules to facilitate the reaction mechanism. The relatively labile OR group may detach readily from the metal atom and exchange with other molecules which have an —OH or COOH functionality. R may be a hydroxy-alkyl group derived from a diol such as 1,4-butane diol or a polyoxyalkyl group such as a dialkylene glycol, polyalkylene glycol, for example diethylene glycol or polyethylene glycol. Preferred R groups include ethyl, n-propyl, isopropyl, n-butyl, t-butyl, pentyl, hexyl or 2-ethyl-hexyl, hydroxybutyl, polyoxyethyl and 2-(2-hydroxyethoxy)-ethyl.

In one embodiment, —OR is an alkoxide derived from a diol, e.g. 1,4-butane diol, diethylene glycol, ethylene glycol or a polyalkylene glycol. In the manufacture of polyurethanes, a short-chain polyol, normally a diol, is often used as a chain extender as part of a mixture of polyols to be reacted with a polyisocyanate. 1,4-butane diol is commonly used as a chain extender for polyurethane reactions. It may therefore be beneficial to provide as the labile OR group of the catalyst a functionalised alkoxide which is to be capable of forming a bis or poly functional alcohol and functioning as a chain extender rather than forming a singly functional alcohol which may have a tendency to terminate the growing polymer chains.

L¹, L² and L³ are each a non-labile group, by which we mean that it is a group which is bonded relatively strongly to the metal atom such that it is not exchanged or inserted by hydroxyl-containing molecules present in the reaction mixture under the conditions of the reaction. Thus the sites on the metal atom occupied by the groups L¹, L² and L³ are not available as active sites for catalysis.

L¹ and L² may be the same or different from each other. L¹ and L² are each independently selected from β-diketonate, an ester or amide of acetoacetic acid, a hydroxycarboxylic acid or ester thereof, R¹COO— where R¹ is substituted or unsubstituted C₁-C₃₀ branched or linear alkyl, substituted or unsubstituted aryl including polycyclic structures such as naphthyl or anthracyl, phosphate, phosphinate, phosphonate, siloxy or sulphonato provided that when L¹ is derived from a ligand which forms two covalent bonds with the metal atom, and x=1 then y=0. R¹ may be substituted by a hydroxy, carbonyl, carboxy, amino, alkoxy or polyalkoxy group or may incorporate a carbonyl, carboxy, amino, alkoxy or polyalkoxy group in its main carbon chain.

L¹ and L² are preferably selected from acetyl acetone, an alkylacetoacetate or an N-alkylacetoacetamide (where alkyl is preferably a C₁ to C₈ alkyl group), such as ethylacetoacetate or N,N-diethylacetoacetamide, a hydroxycarboxylic acid or ester thereof, such as salicylic acid, mandelic acid, levulinic acid, naphthalene dicarboxylic acid, citric acid, lactic acid, tartaric acid. When L¹ is a ligand which forms two covalent bonds with the metal atom such as for example when L¹ is salicylic acid or mandelic acid, and x=1 then y=0 and in this case x+y+z is less than V−1. So for example, when M is Ti and L¹ is salicylic acid, V=4, y=0 and x+y+z=2. Examples of ligands which form two covalent bonds with the metal atom include hydroxycarboxylic acids, such as salicylic acid or esters thereof, a bis-hydroxy compound such as 2-hydroxy-benzyl alcohol (salicyl alcohol), or esters thereof e.g. with a carboxylic acid having a ,carbonyl group such as 3-oxo-butyric acid for example; a substituted phenol, especially a bisphehol compound where two phenol moieties are linked by a hydrocarbon or nitrogen-containing bridge such as 2,2′ethylidene bis (4,6-di-tert-butyl phenolate), symmetrical or unsymmetrical hydrazine- or amine-bridged phenol derivatives.

L¹ or L² may be capable of forming a coordinating bond with the metal atom in addition to a covalent bond so that the total number of bonds formed between M and the L groups is greater than V−1. This may occur when L¹ or L² is a diketonate such as acetylacetone or an alkyl acetoacetate or acetoacetamide which can react with the metal atom at the carbonyl group through the enolate form of the compound and also form a coordinating bond between the electron-donating ester or amide group and the metal. When M is titanium, for example, this leads to a stable complexed form of titanium.

Preferably, when R is alkyl, L¹ and L² are each independently selected from a β-diketonate, an ester or amide of acetoacetic acid, a hydroxycarboxylic acid or ester thereof, siloxy, or a substituted or unsubstituted phenol or naphthol.

It is less preferred that L¹ and L² are selected from substituted or unsubstituted phenol or naphthol, particularly when L³ is a ligand of this type.

L³ is preferably selected from substituted or unsubstituted phenol or naphthol, an alkyl phenol, benzoic acid or a C₂-C₃₀ carboxylic acid, preferably a C₆-C₂₂ carboxylic acid such as stearic, isostearic or 2-ethyl-hexylcarboxylic acid.

In a further embodiment of the invention, we have found that the compositions are particularly effective cure catalysts in certain polyurethane reactant systems when the compositions are mixed with an acid as a further component. The acid is preferably a carboxylic acid which is preferably a liquid under normal handling conditions. Alkyl carboxylic acids, for example a C₂-C₃₀ carboxylic acid, especially a C₄-C₂₂ carboxylic acid such as butyric, stearic, isostearic, oleic or 2-ethyl-hexylcarboxylic acid have been found to be suitable. If the composition contains a carboxylic acid as one of L¹ L² or L³, then it is convenient for the additional carboxylic acid added to the mixture to be the same acid. However this is not necessary and we have found that a different acid may be used and provide a similar beneficial effect. The additional acid may be mixed with the compound of the invention in all proportions. Normally, when the additional acid is present, the proportions of compound: acid used will be in the range 1:99-99:1, more usually 10:90-90:10 by weight, depending upon the molecular weight of the acid and the organometallic compound. Preferably, when present, the additional acid is added at a ratio of from 0.1 to 10 moles of acid per mole of organometallic compound, e.g. from about 0.5 to 5, preferably from about 0.5 to 3 moles of acid per mole of organometallic compound.

It is preferred that catalysts for curing polyurethanes are supplied in a liquid form. The organometallic compositions of the invention may be supplied neat (particularly when the composition is, itself a liquid) or as a solution in a suitable solvent, such as toluene, hexane, heptane etc. More preferably it is supplied in a liquid component which is already present in or which is compatible with the polyurethane reaction components, such as a diol or glycol e.g. butane diol or diethylene glycol.

Without wishing to be bound by theory, it is thought that the composition functions as a cure catalyst by exchange or insertion of the polyol or of the isocyanate at the labile site on the organometallic composition, by displacement of the OR group. For a discussion of the mechanism of titanium-catalysed urethane reactions, see for example Meth-Cohn et al (J. Chem Soc (C), 1970, p. 132).

The compound having more than one hydroxy group which is capable of reacting with an isocyanate group-containing material to form a polyurethane or the compound having more than one isocyanate group which is capable of reacting with a hydroxyl group-containing material to form a polyurethane may comprise a mixture of such compounds or a mixture of such compounds with different compounds, e.g. fillers or other additives etc.

The compound of the invention is particularly useful as a cure catalyst for the reaction between a hydroxy-functionalised molecule, such as a polyol, and an isocyanate-functionalised molecule, such as a polyisocyanate. This reaction forms the basis of many commercially available two-component polyurethane systems. The polyol component may be any suitable for the manufacture of polyurethanes and includes polyester-polyols, polyester-amide polyols, polyether-polyols, polythioetherpolyols, polycarbonate polyols, polyacetal polyols, polyolefin polyols polysiloxane polyols, dispersions or solutions of addition or condensation polymers in polyols of the types described above, often referred to as “polymer” polyols. A very wide variety of polyols has been described in the prior art and is well known to the formulator of polyurethane materials.

Typically, a mixture of polyols is used to manufacture polyurethane having particular physical properties. The polyol or polyols is selected to have a molecular weight, backbone type and hydroxy functionality which is tailored to the requirements of the formulator. Typically the polyol includes a chain extender, which is often a relatively short-chain diol such as 1,4-butane diol or diethylene glycol or a low molecular weight polyethylene glycol. Alternative chain extenders in commercial use, such as diamines, e.g. MOCA (4,4-methylene bis (2-chloroaniline)) may also be used.

The isocyanate compositions used for polyurethane manufacture suitable for use with the catalysts of the present invention may be any organic polyisocyanate compound or mixture of organic polyisocyanate compounds which are commercially useful for the purpose. Preferably the polyisocyanate is liquid at room temperature.

Suitable organic polyisocyanates include diisocyanates, particularly aromatic diisocyanates, and isocyanates of higher functionality. Examples of suitable organic polyisocyanates include aliphatic isocyanates such as hexamethylene diisocyanate and isophorone diisocyanate; and aromatic isocyanates such as m- and p-phenylene diusocyanate, tolylene-2,4- and tolylene-2,6-diisocyanate, diphenylmethane-4,4′-diisocyanate, chlorophenylene-2,4-diisocyanate, naphthylene-1,5-diisocyanate, diphenylene-4,4′-diisocyanate, 4,4′-diisocyanate-3,3′-dimethyl-diphenyl, 3-methyldiphenylmethane-4,4′-di-isocyanate and diphenyl ether diisocyanate; and cycloaliphatic diisocyanates such as cyclohexane-2,4- and -2,3-diisocyanate, 1-methylcyclohexyl-2,4- and -2,6-diisocyanate and mixtures thereof and bis-(isocyanatocyclohexyl)methane and triisocyanates such as 2,4,6-triisocyanatotoluene and 2,4,4-tri-isocyanatodiphenylether.

Modified polyisocyanates containing isocyanurate, carbodiimide or uretonimine groups may be used. The polyisocyanate may also be an isocyanate-ended prepolymer made by reacting an excess of a diisocyanate or higher functionality polyisocyanate with a polyol for example a polyether polyol or a polyester polyol. The use of prepolymers is common in commercially available polyurethane systems. In these cases, polyols may already be incorporated in the isocyanate or prepolymer whilst further components such as chain extenders, polyols etc may be mixed with the isocyanate prepolymer mixture before polymerisation.

Mixtures of isocyanates may be used in conjunction with the organometallic composition of the invention, for example a mixture of tolylene diisocyanate isomers such as the commercially available mixtures of 2,4- and 2,6-isomers. A mixture of di- and higher polyisocyanates, such as trimers (isocyanurates) or pre-polymers, may also be used. Polyisocyanate mixtures may optionally contain monofunctional isocyanates such as p-ethyl phenylisocyanate.

The organometallic composition of the invention is typically added to the polyol prior to mixing together the polyol component with the isocyanate component to form the polyurethane. However, the organometallic composition may instead be added to the isocyanate component if required.

A composition containing a catalyst composition of the present invention and a polyisocyanate and compounds reactive therewith may further comprise conventional additives such as chain modifiers, diluents, flame retardants, blowing agents, release agents, water, coupling agents, lignocellulosic preserving agents, fungicides, waxes, sizing agents, fillers, colourants, impact modifiers, surfactants, thixotropic agents, flame retardants, plasticisers, and other binders. The selection of these and other ingredients for inclusion in a formulation for a polyurethane composition is well known to the skilled person and may be selected for the particular purpose. When the mixture has been allowed to cure it may be further conditioned to allow for post-cure. Typically this occurs when the polyurethane article, coating etc has hardened to a state in which it may be handled, demoulded etc and then it may be held at elevated temperature, e.g. by placing in an oven, to develop or enhance the full cured properties of the article.

The catalysts of the present invention are useful for the manufacture of polyurethane foams, flexible or rigid articles, coatings, adhesives, elastomers, sealants, thermoplastic polyurethanes, and binders e.g. for oriented strand board manufacture. The catalysts of the present invention may also be useful in preparing polyurethane prepolymers, i.e. urethane polymers of relatively low molecular weight which are supplied to end-users for curing into polyurethane articles or compositions of higher molecular weight.

The catalysts are typically present in the isocyanate and/or alcohol mixture to give a concentration in the range 1×10⁻⁴ to 10% by weight, preferably up to about 4% by weight based upon the weight of the total reaction system, i.e. the total weight of the polyisocyanate and polyol components.

The invention will be further described in the following examples.

### EXAMPLE 1

### Ti(OCH(CH₃)₂) (OC₆H₅)₃

Titanium tetra(isopropoxide) (VERTEC™ TIPT) (40 g, 0.14 mole) was reacted with phenol (39.7 g, 0.42 mole) in a rotary evaporator flask for approximately 30 minutes and then displaced isopropyl alcohol (IPA) was removed by distillation in vacuum. The product was semi-solid at room temperature. In order to ensure that no IPA was trapped in the product, a portion of n-hexane was added to it with stirring to dissolve all the product, and then it was distilled again at 30 in/Hg. The product was semi-solid. The yield was 98.78%.

### EXAMPLE 2

### Ti(OCH(CH₃)₂) (OC₆H₄CH₃)₃

The procedure of Example 1 was repeated except that TIPT (35 g, 0.12 mole) was reacted with 2-methyl phenol (40 g, 0.37 mole). The product was semi-solid at room temperature. Yield was 100%.

### EXAMPLE 3

### Ti(OCH(CH₃)₂)(CH₃COCH₂COCH₃)₂(OC₆H₅)

TIPT was reacted with acetyl acetone at a mole ratio of 1 mole TIPT:2 moles acetyl acetone. The resulting compound, “Precursor 3”,an orange-red liquid, (49 g, 0.10 mole) was reacted with phenol (9.5 g, 0.10 mole) in a rotary evaporator flask for approximately 30 minutes and then distilled in a vacuum at 60° C. to remove displaced IPA. The product was semi-solid at room temperature. Yield was 97.2%.

### EXAMPLE 4

### Ti(OCH(CH₃)₂)(CH₃COCH₂COCH₃)₂(OCOC₁₇H₃₅)

A portion of the orange-red liquid Precursor 3 (50 g, 0.10 mole) was reacted with isostearic acid (29.34 g, 0.10 mole) in a rotary evaporator flask for approximately 30 minutes and then distilled in a vacuum at 60° C. to remove displaced IPA. The product was semi-solid at room temperature. Yield was 99%.

### EXAMPLE 5

### Ti(OCH(CH₃)₂)(OC₆H₅)(C₂H₅OCOCH₂COCH₃)₂

TIPT was reacted with ethyl acetoacetate at a mole ratio of 1 mole TIPT: 2 moles ethyl acetoacetate and the product was distilled to remove 2 moles IPA per mole of TIPT. The resulting product, which was an orange semi-solid at room temperature, (50.0 g, 0.12 mole) was reacted with phenol (11.1 g, 0.12 mole) in a rotary evaporator flask for approximately 30 minutes and then distilled in a vacuum to remove displaced IPA. The product was semi-solid at room temperature. The yield was 98.5%.

### EXAMPLE 6

### Ti(OCH(CH₃)₂)(OCOC₆H₄O)(OCOC₁₇H35)

14.5 g, (0.1056 mole) of salicylic acid was dissolved in about 116 g of IPA. TIPT (30 g, 0.11 mole) was added drop-wise to the acid solution, shaken to dissolve the precipitate which formed and then mixed for about 30 minutes in a rotary evaporator. Some precipitates formed. On addition of iso-stearic acid (30 g. 0.1056 mole) the precipitates dissolved to give a clear orange solution. All formed IPA was removed from the solution at 60° C. under vacuum. The product was a viscous liquid at room temperature.

### EXAMPLE 7

### Ti(OC₂H₄OC₂H₄OH)(OC₆H₅)₃

To a catalyst prepared by the method of Example 1 was added 0.14 mole of diethylene glycol (DEG) to replace 0.14 mole of IPA. A 50% solution of the resulting catalyst in DEG was prepared.

### EXAMPLE 8

### Ti(OC₂H₄OC₂H₄OH)(CH₃COCH₂COCH₃)₂(OCOC₁₇H₃₅)

Catalyst was prepared in the exactly same method as Example 4, then 0.10 mole of DEG was added to replace 0.10 mole of IPA. A 50% solution of catalyst in DEG was prepared.

### EXAMPLE 9

### Ti(OC₂H₄OC₂H₄OH)(OCOC₆H₄O)(OCOC₁₇H₃₅)

Catalyst was prepared in the exactly same method as Example 6, then (0.11 mole) of DEG was added to replace (0.11 mole) of IPA. A 50% solution of catalyst in DEG was prepared.

### EXAMPLE 10

### Ti(OC₂H₄OC₂H₄OH)₂(CH₃COCH₂COCH₃)₂

Precursor 3 (50 g, 0.10 mole) was placed in a rotary evaporator to which DEG (21.8 g, 0.21 mole) was added. All replaced IPA was removed by distillation under vacuum. A 50% solution of the catalyst in DEG was prepared.

### COMPARATIVE EXAMPLE 11

### Ti(OCH(CH₃)₂) (OCOC₁₇H₃₅)₃

TIPT (10 g, 0.04 mole) was reacted with isostearic acid (30.01 g, 0.11 mole) in a rotary evaporator flask for approximately 30 minutes and then distilled in a vacuum at 60° C. to remove displaced IPA. The product was viscous-liquid at room temperature and incorporated some IPA which was not removed, even when the temperature was raised to 120° C.

### EXAMPLE 12

### Zr(OC₃H₇)(OCOC₆H₄O)(OCOC₁₇H₃₅)

44.5 g of VERTEC™ NPZ (containing 0.1 mole of tetra n-propyl zirconium in n-propanol) was placed in a flask and 28.75 g (0.10 moles) of isostearic acid was added with stirring. The mixture was distilled under reduced pressure(30″) at a temperature of 70° C. to remove 20.5 g of n-propanol. 14.5 g, (0.11 mole) of salicylic acid was dissolved in about 47 g of n-propanol and added to the mixture in the flask. A further 58 g of n-propanol was removed by under reduced pressure(30″ Hg) at a temperature of 70° C. leaving 55 g of the pale green-yellow solid product.

### EXAMPLE 13

### Ti(DEAA)₂(1-naphthol)(OCH(CH₃)₂)

110 g (0.70 moles) of N,N-diethylacetoacetamide (DEAA) was added very slowly, with stirring, to 100 g (0.35 moles) of TIPT in a rotary flask. The reaction was exothermic. The mixture was distilled under reduced pressure (30″ Hg) at a temperature of 60° C. to remove 42 g of 2-propanol. 50.78 g of 1-naphthol was added to the mixture in the flask. The remaining 2-propanol (0.35 mol, 20 g) was then removed by reduced pressure distillation.

### EXAMPLE 14

### Curing of Polyurethane Mixtures Using the Catalysts of Examples 1-10

A small amount of catalyst (see table 1) was put in a cup, together with 22 g of a commercially available polyether polyol having a molecular weight between 1000 and 2000 containing a moisture scavenger, a silica-based filler and 1,4-butane diol as a chain extender. The catalyst and polyol were mixed in a high-speed mixer at 3000 rpm. An isocyanate prepolymer based on 4,4′methylenebis (phenyl isocyanate) (10 g) was added and the mixture was again mixed in the mixer. The mixture was then poured into a disposable smooth-walled aluminium weighing dish. A thermocouple wire was Inserted into the mixture to record the exotherm value at regular intervals of 30 seconds. The time for the mixture to become tack-free and dry were recorded. When the moulding became tack-free, it was subjected to hardness measurement using a BAREISS HHP-2001 hardness tester to measure shore A hardness as described in DIN 53505.

The cure and testing was carried out as described using catalysts prepared in the Examples and also a commercially available mercury-based catalyst, phenyl mercury neodecanoate, (designated in the table as “Hg-at”) as a comparison. The results are shown in Table 1.

TABLE 1

| | Amount of metal | Max exotherm | Tack-free time | Shore A hardness | | |
|---|---|---|---|---|---|---|
| Catalyst | (mmol) | (° C.) | (minutes) | 1 hour | 24 hours | Appearance |
| Hg-cat | 0.23 | 90 | 8 | 40 | 65 | v. glossy |
| Ex 4 | 0.02 | 93 | 1 | 50 | 90 | v. glossy |
| Ex 7 | 0.03 | 82 | 3 | 48 | 73 | Glossy |
| Ex 8 | 0.02 | 70 | 5 | 65 | 95 | Glossy |
| Ex 9 | 0.08 | 65 | — | 40 | 82 | matt |
| Ex 10 | 0.02 | 72 | 3 | 64 | 79 | v. glossy |

The results show that the catalysts of the invention are capable of curing polyurethane mixtures and give cured products having properties similar to or better than those made using the comparison mercury-based catalyst, even though the catalysts of the invention are used in smaller quantities than the mercury catalyst.

### EXAMPLE 15

The catalyst made in Example 6 (2.17 g, 4.51 mmols per 100 g of polyol) was added to a mixing vessel. A polyol containing MOCA (4,4′methylene-bis[2-chloroaniline]) (68.3 g) was added to the vessel and mixed for 30 seconds, at 3000 rpm. A prepolymer containing TDI (100 g) was added to the vessel and mixed for 30 seconds, at 3000 rpm. The mixture was then transferred into an aluminium cup at a depth of 8 mm allowed to cure and measured for Shore A Hardness as before. A similar procedure was followed using (tetra-n-butyl)titanate (VERTEC™ TNBT) for comparison. The results are shown in Table 2.

TABLE 2

| | Shore A Hardness | |
|---|---|---|
| Catalyst | (after 24 hrs @ 25° C.) | Observations |
| Comparison | 20 | Product is very sticky and tacky. |
| (TNBT) | | |
| Example 6 | 57 | Product is tack free. |

### EXAMPLE 16

The catalysts were tested with and without the addition of an acid to the catalyst composition by the general procedure described in Example 15. When acid was used, the catalyst and acid were blended together to form a stable solution of the organometallic compound in the acid. The compositions were added to the polyol in a quantity calculated to provide 4.51 mmoles of metal per 100 g of polyol. After the isocyanate had been added, the compositions were cured in an oven at 82° C. The hardness was measured every hour for four hours. The compositions used and the results are shown in Table 3.

TABLE 3

| | | % w/w | Catalyst (g) | Shore A Hardness Results | | | |
|---|---|---|---|---|---|---|---|
| | | catalyst in | per 100 g | 1 hr @ | 2 hr @ | 3 hr @ | 4 hr @ |
| Catalyst | Acid | acid | polyol | 82° C. | 82° C. | 82° C. | 82° C. |
| Example 6 | — | — | 2.164 | 66 | 71 | 75 | 75 |
| Example 6 | isostearic | 68.5 | 2.164 | 71 | 76 | 77 | 77 |
| Example 6 | oleic | 68.5 | 2.164 | 70 | 70 | 73 | 75 |
| Example 12 | isostearic | 50.0 | 2.517 | 66 | 68 | 71 | 72 |

1. An organometallic compound of formula RO-M(L¹)ₓ(L²)_{y}(L³)_{z}
wherein M is a metal selected from titanium, zirconium, hafnium, iron (III), cobalt (III) or aluminium;
R is alkyl or a hydroxy-alkyl, hydroxyalkoxyalkyl, or (hydroxy)polyoxyalkyl group, and
(i) when R is alkyl, L¹ and L² are each independently selected from a β-diketonate, an ester or amide of acetoacetic acid, a hydroxycarboxylic acid or ester thereof or siloxy,
(ii) when R is a hydroxy-alkyl, hydroxyalkoxyalkyl, or (hydroxy)polyoxyalkyl group, L¹ and L² are each independently selected from a diketonate, an ester or amide of acetoacetic acid, a hydroxycarboxylic acid or ester thereof, R¹COO— where R¹ is substituted or unsubstituted C₁-C₃₀ branched or linear alkyl, substituted or unsubstituted aryl including polycyclic structures phosphate, phosphinate, phosphonate, siloxy or sulphonato;
in both case (i) and case (ii), provided that when L¹ is a ligand which forms two covalent bonds with the metal atom, and x=1 then y=0;
L³ is selected from substituted or unsubstituted phenol or naphthol, R²COO— where R² is a linear or branched C₁-C₃₀ alkyl or benzene, a polyoxyalkoxy or hydroxyalkoxyalkoxy group;
x and y are each either 0 or 1,
z=1
(x+y+z)≦V−1, where V=the valency of the metal M.

2. An organometallic compound according to claim 1, wherein R is a C₁-C₈ alkyl group or a hydroxy-alkyl group derived from a diol.

3. An organometallic compound according to claim 2, wherein R is selected from the group consisting of ethyl, n-propyl, isopropyl, n-butyl, t-butyl, pentyl, hexyl, hydroxybutyl, polyoxyethyl and 2-(2-hydroxyethoxy)-ethyl.

4. An organometallic compound according to claim 1, wherein L¹ and L² are selected from the group consisting of acetyl acetone, an alkylacetoacetate, an N-alkylacetoacetamide, salicylic acid or ester thereof, mandelic acid or ester thereof, levulinic acid or ester thereof, or naphthalene dicarboxylic acid or ester thereof.

5. An organometallic compound according to claim 1, wherein L³ is selected from the group consisting of substituted or unsubstituted phenol or naphthol, or a C₂-C₃₀ carboxylic acid.

6. A cure catalyst composition, suitable for catalysing the formation of urethane bonds, comprising a mixture of an organometallic compound according to claim 1 and an acid.

7. A cure catalyst composition according to claim 6, wherein said organometallic compound and said acid are mixed together in a mole ratio of from 0.1 to 10 moles of acid per mole of organometallic compound.

8. A cure catalyst composition according to either claim 6, wherein the acid is a C₂-C₃₀ carboxylic acid.

9. A composition comprising:
a) either
i) a compound having more than one hydroxy group which is capable of reacting with an isocyanate group-containing material to form a polyurethane or
ii) a compound having more than one isocyanate group which is capable of reacting with a hydroxyl group-containing material to form a polyurethane, and
b) an organometallic compound of formula RO—M(L¹)ₓ(L²)_{y}(L³)_{z}
wherein M is a metal selected from titanium, zirconium, hafnium, iron (III), cobalt (III) or aluminium;
R is alkyl or a hydroxy-alkyl, hydroxyalkoxyalkyl, or (hydroxy)polyoxyalkyl group, and
(i) when R is alkyl, L¹ and L² are each independently selected from a β-diketonate, an ester or amide of acetoacetic acid, a hydroxycarboxylic acid or ester thereof or siloxy,
(ii) when R is a hydroxy-alkyl hydroxyalkoxyalkyl, or (hydroxy)polyoxyalkyl group, L¹ and L² are each independently selected from a diketonate, an ester or amide of acetoacetic acid, a hydroxycarboxylic acid or ester thereof, R¹COO— where R¹ is substituted or unsubstituted C₁-C₃₀ branched or linear alkyl, substituted or unsubstituted aryl including polycyclic structures phosphate, phosphinate, phosphonate, siloxy or sulphonato;
in both case (i) and case (ii), provided that when L¹ is a ligand which forms two covalent bonds with the metal atom, and x=1 then y=0;
L³ is selected from substituted or unsubstituted phenol or naphthol, R²COO— where R² is a linear or branched C₁-C₃₀ alkyl or benzene, a polyoxyalkoxy or hydroxyalkoxyalkoxy group;
x and y are each either 0 or 1,
z=1
(x+y+z )≦V−1, where V=the valency of the metal M.

10. A composition according to claim 9, wherein when R is alkyl, L¹ and L² are each independently selected from the group consisting of a β-diketonate, an ester or amide of acetoacetic acid, a hydroxycarboxylic acid or ester thereof, or siloxy.

11. A composition according to claim 10, further comprising an acid.

12. A composition according to claim 11, wherein the acid is intimately mixed with the organometallic compound of component b).

13. A composition according to claim 11, wherein the acid is a C₂-C₃₀ carboxylic acid.

14. A process for manufacturing an organometallic composition, comprising reacting together:
(a) a metal alkoxide, having a formula M(OR)v, where:
M is a metal selected from titanium, zirconium, hafnium, iron (III), cobalt (III) or aluminium;
V=the valency of the metal M, and
R is alkyl, and
(b) a β-diketone, an ester or amide of acetoacetic acid, a hydroxycarboxylic acid or ester thereof, R¹COO— where R¹ is substituted or unsubstituted C₁-C₃₀ branched or linear alkyl, substituted or unsubstituted aryl including polycyclic structures phosphate, phosphinate, phosphonate, siloxy or sulphonato; in an amount to provide about 1 or 2 moles of component (b) per mole of metal M in component (a); and
(c) a substituted or unsubstituted aryloxy, R²COO— where R² is a linear or branched C₁-C₃₀ alkyl or a substituted or unsubstituted aryl, a polyoxyalkylalcohol or hydroxyalkoxyalcohol in an amount to provide about 1 mole of component (c) per mole of metal M in component (a).

15. (canceled)

16. A process according to claim 14, wherein the metal alkoxide M(OR)ᵥ is first reacted with one of component (b) or component (c) and then with the other of components (b) or (c) and the alcohol ROH formed during the reaction of the alkoxide with components (b) and (c) is removed after each reaction step.

17. A process according to claim 14, wherein the product is further reacted with a hydroxy-functionalised alcohol which is preferably a hydroxy-alcohol, hydroxyalkoxyalcohol, or (hydroxy)polyoxyalkylalcohol and a further quantity of ROH is removed from the reaction mixture.

18. A process for the manufacture of a polyurethane article, comprising the steps of:
a) forming a mixture by mixing together either
i) a compound having more than one hydroxy group which is capable of reacting with an isocyanate group-containing material to form a polyurethane or
ii) a compound having more than one isocyanate group which is capable of reacting
with a hydroxyl group-containing material to form a polyurethane,
with an organometallic compound of formula RO-M(L¹)ₓ(L²)_{y}(L³)_{z}
wherein M is a metal selected from titanium, zirconium, hafnium, iron (III), cobalt (III) or aluminium;
L¹ and L² are each independently selected from a diketonate, an ester or amide of acetoacetic acid, a hydroxycarboxylic acid or ester thereof, R¹COO— where R¹ is substituted or unsubstituted C₅-C₃₀ branched or linear alkyl, substituted or unsubstituted aryl including polycyclic structures phosphate, phosphinate, phosphonate, siloxy or sulphonato, provided that when L¹ is a ligand which forms two covalent bonds with the metal atom, and x=1 then y=0;
L³ is selected from substituted or unsubstituted aryloxy, R²COO— where R² is a linear or branched C₆-C₃₀ alkyl, and a polyoxyalkyl or hydroxyalkoxyalkyl group;
R is alkyl or hydroxy-alkyl hydroxyalkoxyalkyl, or (hydroxy)polyoxyalkyl group,
x, y and z are each either 0 or 1
(x+y+z)≦V−1, where V=the valency of the metal M;
b) adding to said mixture the other of the compound having more than one hydroxy group which is capable of reacting with an isocyanate group-containing material to form a polyurethane or the a compound having more than one isocyanate group which is capable of reacting with a hydroxyl group-containing material to form a polyurethane,
c) forming said mixture into the required shape for the polyurethane article,
d) allowing said mixture to cure.

19. An organometallic compound according to claim 1, wherein R is a substituted or unsubstituted aryl including polycyclic structures selected from the group consisting of naphthyl and anthracyl.

20. A composition according to claim 9, wherein R is a substituted or unsubstituted aryl including polycyclic structures selected from the group consisting of naphthyl and anthracyl.

21. A process according to claim 18, wherein R¹ is a substituted or unsubstituted aryl including polycyclic structures selected from the group consisting of naphthyl and anthracyl.

22. A composition according to claim 9, further comprising one or more components selected from chain modifiers, diluents, flame retardants, blowing agents, release agents, water, coupling agents, lignocellulosic preserving agents, fungicides, waxes, sizing agents, fillers, colourants, impact modifiers, surfactants, thixotropic agents, flame retardants, plasticisers, and other binders.

23. A process according to claim 14 further comprising (d) removing alcohol ROH formed during the reaction of (a) with (b) and (c).

24. A process according to claim 18 further comprising optionally subjecting the mixture to specified conditions for post-cure conditioning.

25. A cure catalyst composition according to either claim 7, wherein the acid is a C₂-C₃₀ carboxylic acid.
